(19) United States
(12) Patent Application Publication
(10) Pub. No.: US 2019/0360717 A1
(43) Pub. Date: Nov. 28, 2019

(54) ARTIFICIAL INTELLIGENCE DEVICE CAPABLE OF AUTOMATICALLY CHECKING VENTILATION SITUATION AND METHOD OF OPERATING THE SAME

(71) Applicant: LG ELECTRONICS INC., Seoul (KR)

(72) Inventor: Seungah CHAE, Seoul (KR)

(73) Assignee: LG ELECTRONICS INC., Seoul (KR)

(21) Appl. No.: 16/539,532

(22) Filed: Aug. 13, 2019

(30) Foreign Application Priority Data
Jul. 4, 2019 (KR) 10-2019-0080981

(51) Int. Cl. F24F 11/63; F24F 11/52; G05B 13/02

(52) U.S. Cl. CPC F24F 11/63; F24F 2110/64; G05B 13/027; F24F 11/52

(57) ABSTRACT

An artificial intelligence (AI) device capable of automatically checking a ventilation situation includes a memory, a communication unit configured to wirelessly perform communication with an external AI device, and a processor configured to acquire indoor air quality information and outdoor air quality information, determine whether ventilation is necessary based on the acquired indoor air quality information, acquire a ventilation time based on the indoor air quality information and the outdoor air quality information when ventilation is necessary, and transmit, to the external AI device, an OFF command for turning off operation of the external AI device during the acquired ventilation time.

### CROSS-REFERENCE TO RELATED APPLICATIONS

Pursuant to 35 U.S.C. § 119(a), this application claims the benefit of earlier filing date and right of priority to Korean Patent Application No. 10-2019-0080981, filed on Jul. 4, 2019, the contents of which are hereby incorporated by reference herein in its entirety.

### BACKGROUND

The present invention relates to an artificial intelligence (AI) device capable of automatically checking a ventilation situation and a method of operating the same.

In general, when a person works for a long time in a state in which a building is not ventilated well, CO2 and fine dust increase and thus a room cannot be maintained in a comfortable condition. Therefore, it is necessary to ventilate the room.

To this end, conventionally, a user opened windows after manually turning off an air conditioner or an air purifier, in order to ventilate the room.

However, the user cannot determine how long the room needs to be ventilated. In addition, it is inconvenient to manually turn off the air conditioner or the air purifier.

In addition, even when ventilation has ended, it is inconvenient to manually turn on the air conditioner or the air purifier.

### SUMMARY

An object of the present invention is to automatically determine a ventilation situation and automatically turn off an external device for performing unnecessary operation at the time of ventilation.

Another object of the present invention is to infer a ventilation time and automatically turn off an external device for performing unnecessary operation during the ventilation time.

Another object of the present invention is to automatically turn on an external device after a ventilation time has ended.

An artificial intelligence (AI) device capable of automatically checking a ventilation situation according to an embodiment of the present invention includes a memory, a communication unit configured to wirelessly perform communication with an external AI device, and a processor configured to acquire indoor air quality information and outdoor air quality information, determine whether ventilation is necessary based on the acquired indoor air quality information, acquire a ventilation time based on the indoor air quality information and the outdoor air quality information when ventilation is necessary, and transmit, to the external AI device, an OFF command for turning off operation of the external AI device during the acquired ventilation time.

A method of operating an artificial intelligence (AI) device capable of automatically checking a ventilation situation according to another embodiment of the present invention includes acquiring indoor air quality information and outdoor air quality information, determining whether ventilation is necessary based on the acquired indoor air quality information, acquiring a ventilation time based on the indoor air quality information and the outdoor air quality information, when the ventilation is necessary, and transmitting, to an external AI device, an OFF command for turning off operation of the external AI device during the acquired ventilation time.

### BRIEF DESCRIPTION OF THE DRAWINGS

FIG. 1 is a view showing an artificial intelligence (AI) device according to an embodiment of the present invention.

FIG. 2 is a view showing an AI server according to an embodiment of the present invention.

FIG. 3 is a view showing an AI system according to an embodiment of the present invention.

FIG. 4 is a view showing an artificial intelligence (AI) device according to another embodiment of the present invention.

FIG. 5 is a flowchart illustrating a method of operating an AI device according to an embodiment of the present invention.

FIG. 6 is a view illustrating an example of outputting a notification indicating that ventilation is necessary according to an embodiment of the present invention.

FIG. 7 is a view illustrating a ventilation time inference model according to an embodiment of the present invention.

FIG. 8 is a view showing an example of learning data used to learn the ventilation time inference model.

FIG. 9 is a view illustrating a process of turning off operation of an external AI device during a ventilation time according to an embodiment of the present invention.

FIG. 10 is a view illustrating a process of transmitting an ON command to an external AI device when ventilation ends according to an embodiment of the present invention.

FIG. 11 is a view illustrating a notification indicating that ventilation may be extended when ventilation has ended according to an embodiment of the present invention.

### DETAILED DESCRIPTION OF THE EMBODIMENTS

<Artificial Intelligence (AI)>

Artificial intelligence refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and may mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network may include an input layer, an output layer, and optionally one or more hidden layers. Each layer includes one or more neurons, and the artificial neural network may include a synapse that links neurons to neurons. In the artificial neural network, each neuron may output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network may be to determine the model parameters that minimize a loss function. The loss function may be used as an index to determine optimal model parameters in the learning process of the artificial neural network.

Machine learning may be classified into supervised learning, unsupervised learning, and reinforcement learning according to a learning method.

The supervised learning may refer to a method of learning an artificial neural network in a state in which a label for learning data is given, and the label may mean the correct answer (or result value) that the artificial neural network must infer when the learning data is input to the artificial neural network. The unsupervised learning may refer to a method of learning an artificial neural network in a state in which a label for learning data is not given. The reinforcement learning may refer to a learning method in which an agent defined in a certain environment learns to select a behavior or a behavior sequence that maximizes cumulative compensation in each state.

Machine learning, which is implemented as a deep neural network (DNN) including a plurality of hidden layers among artificial neural networks, is also referred to as deep learning, and the deep running is part of machine running. In the following, machine learning is used to mean deep running.

<Robot>

A robot may refer to a machine that automatically processes or operates a given task by its own ability. In particular, a robot having a function of recognizing an environment and performing a self-determination operation may be referred to as an intelligent robot.

Robots may be classified into industrial robots, medical robots, home robots, military robots, and the like according to the use purpose or field.

The robot includes a driving unit may include an actuator or a motor and may perform various physical operations such as moving a robot joint. In addition, a movable robot may include a wheel, a brake, a propeller, and the like in a driving unit, and may travel on the ground through the driving unit or fly in the air.

<Self-Driving>

Self-driving refers to a technique of driving for oneself, and a self-driving vehicle refers to a vehicle that travels without an operation of a user or with a minimum operation of a user.

For example, the self-driving may include a technology for maintaining a lane while driving, a technology for automatically adjusting a speed, such as adaptive cruise control, a technique for automatically traveling along a predetermined route, and a technology for automatically setting and traveling a route when a destination is set.

The vehicle may include a vehicle having only an internal combustion engine, a hybrid vehicle having an internal combustion engine and an electric motor together, and an electric vehicle having only an electric motor, and may include not only an automobile but also a train, a motorcycle, and the like.

At this time, the self-driving vehicle may be regarded as a robot having a self-driving function.

<eXtended Reality (XR)>

Extended reality is collectively referred to as virtual reality (VR), augmented reality (AR), and mixed reality (MR). The VR technology provides a real-world object and background only as a CG image, the AR technology provides a virtual CG image on a real object image, and the MR technology is a computer graphic technology that mixes and combines virtual objects into the real world.

The MR technology is similar to the AR technology in that the real object and the virtual object are shown together. However, in the AR technology, the virtual object is used in the form that complements the real object, whereas in the MR technology, the virtual object and the real object are used in an equal manner.

The XR technology may be applied to a head-mount display (HMD), a head-up display (HUD), a mobile phone, a tablet PC, a laptop, a desktop, a TV, a digital signage, and the like. A device to which the XR technology is applied may be referred to as an XR device.

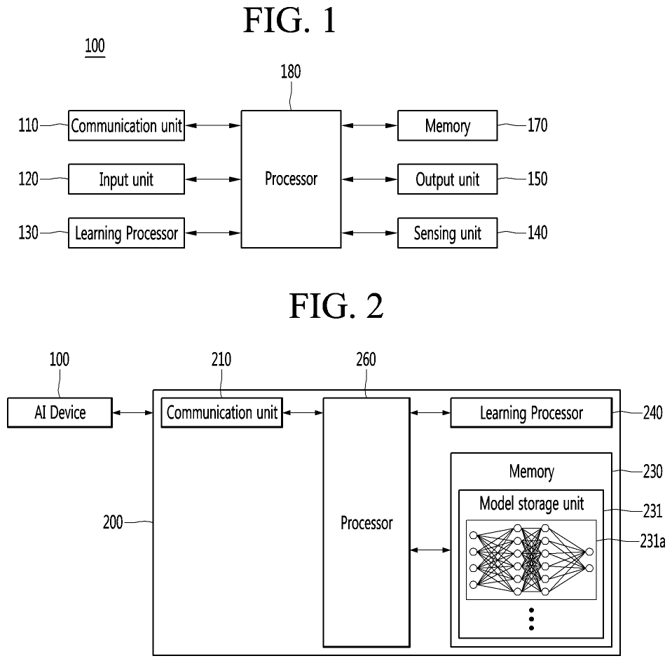

FIG. 1 illustrates an AI device 100 according to an embodiment of the present invention.

The AI device 100 may be implemented by a stationary device or a mobile device, such as a TV, a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like.

Referring to FIG. 1, the AI device 100 may include a communication unit 110, an input unit 120, a learning processor 130, a sensing unit 140, an output unit 150, a memory 170, and a processor 180.

The communication unit 110 may transmit and receive data to and from external devices such as other AI devices 100a to 100e and the AI server 200 by using wire/wireless communication technology. For example, the communication unit 110 may transmit and receive sensor information, a user input, a learning model, and a control signal to and from external devices.

The communication technology used by the communication unit 110 includes GSM (Global System for Mobile communication), CDMA (Code Division Multi Access), LTE (Long Term Evolution), 5G, WLAN (Wireless LAN), Wi-Fi (Wireless-Fidelity), Bluetooth™ RFID (Radio Frequency Identification), Infrared Data Association (IrDA), ZigBee, NFC (Near Field Communication), and the like.

The input unit 120 may acquire various kinds of data.

At this time, the input unit 120 may include a camera for inputting a video signal, a microphone for receiving an audio signal, and a user input unit for receiving information from a user. The camera or the microphone may be treated as a sensor, and the signal acquired from the camera or the microphone may be referred to as sensing data or sensor information.

The input unit 120 may acquire a learning data for model learning and an input data to be used when an output is acquired by using learning model. The input unit 120 may acquire raw input data. In this case, the processor 180 or the learning processor 130 may extract an input feature by preprocessing the input data.

The learning processor 130 may learn a model composed of an artificial neural network by using learning data. The learned artificial neural network may be referred to as a learning model. The learning model may be used to an infer result value for new input data rather than learning data, and the inferred value may be used as a basis for determination to perform a certain operation.

At this time, the learning processor 130 may perform AI processing together with the learning processor 240 of the AI server 200.

At this time, the learning processor 130 may include a memory integrated or implemented in the AI device 100. Alternatively, the learning processor 130 may be implemented by using the memory 170, an external memory directly connected to the AI device 100, or a memory held in an external device.

The sensing unit 140 may acquire at least one of internal information about the AI device 100, ambient environment information about the AI device 100, and user information by using various sensors.

Examples of the sensors included in the sensing unit 140 may include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, and a radar.

The output unit 150 may generate an output related to a visual sense, an auditory sense, or a haptic sense.

At this time, the output unit 150 may include a display unit for outputting time information, a speaker for outputting auditory information, and a haptic module for outputting haptic information.

The memory 170 may store data that supports various functions of the AI device 100. For example, the memory 170 may store input data acquired by the input unit 120, learning data, a learning model, a learning history, and the like.

The processor 180 may determine at least one executable operation of the AI device 100 based on information determined or generated by using a data analysis algorithm or a machine learning algorithm. The processor 180 may control the components of the AI device 100 to execute the determined operation.

To this end, the processor 180 may request, search, receive, or utilize data of the learning processor 130 or the memory 170. The processor 180 may control the components of the AI device 100 to execute the predicted operation or the operation determined to be desirable among the at least one executable operation.

When the connection of an external device is required to perform the determined operation, the processor 180 may generate a control signal for controlling the external device and may transmit the generated control signal to the external device.

The processor 180 may acquire intention information for the user input and may determine the user's requirements based on the acquired intention information.

The processor 180 may acquire the intention information corresponding to the user input by using at least one of a speech to text (STT) engine for converting speech input into a text string or a natural language processing (NLP) engine for acquiring intention information of a natural language.

At least one of the STT engine or the NLP engine may be configured as an artificial neural network, at least part of which is learned according to the machine learning algorithm. At least one of the STT engine or the NLP engine may be learned by the learning processor 130, may be learned by the learning processor 240 of the AI server 200, or may be learned by their distributed processing.

The processor 180 may collect history information including the operation contents of the AI apparatus 100 or the user's feedback on the operation and may store the collected history information in the memory 170 or the learning processor 130 or transmit the collected history information to the external device such as the AI server 200. The collected history information may be used to update the learning model.

The processor 180 may control at least part of the components of AI device 100 so as to drive an application program stored in memory 170. Furthermore, the processor 180 may operate two or more of the components included in the AI device 100 in combination so as to drive the application program.

FIG. 2 illustrates an AI server 200 according to an embodiment of the present invention.

Referring to FIG. 2, the AI server 200 may refer to a device that learns an artificial neural network by using a machine learning algorithm or uses a learned artificial neural network. The AI server 200 may include a plurality of servers to perform distributed processing, or may be defined as a 5G network. At this time, the AI server 200 may be included as a partial configuration of the AI device 100, and may perform at least part of the AI processing together.

The AI server 200 may include a communication unit 210, a memory 230, a learning processor 240, a processor 260, and the like.

The communication unit 210 can transmit and receive data to and from an external device such as the AI device 100.

The memory 230 may include a model storage unit 231. The model storage unit 231 may store a learning or learned model (or an artificial neural network 231a) through the learning processor 240.

The learning processor 240 may learn the artificial neural network 231a by using the learning data. The learning model may be used in a state of being mounted on the AI server 200 of the artificial neural network, or may be used in a state of being mounted on an external device such as the AI device 100.

The learning model may be implemented in hardware, software, or a combination of hardware and software. If all or part of the learning models are implemented in software, one or more instructions that constitute the learning model may be stored in memory 230.

The processor 260 may infer the result value for new input data by using the learning model and may generate a response or a control command based on the inferred result value.

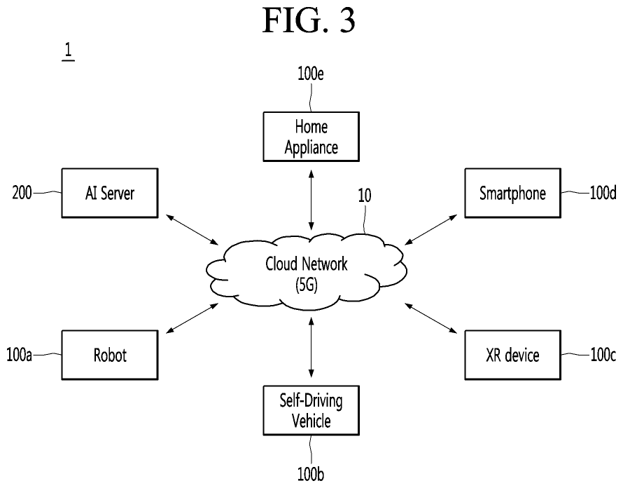

FIG. 3 illustrates an AI system 1 according to an embodiment of the present invention.

Referring to FIG. 3, in the AI system 1, at least one of an AI server 200, a robot 100a, a self-driving vehicle 100b, an XR device 100c, a smartphone 100d, or a home appliance 100e is connected to a cloud network 10. The robot 100a, the self-driving vehicle 100b, the XR device 100c, the smartphone 100d, or the home appliance 100e, to which the AI technology is applied, may be referred to as AI devices 100a to 100e.

The cloud network 10 may refer to a network that forms part of a cloud computing infrastructure or exists in a cloud computing infrastructure. The cloud network 10 may be configured by using a 3G network, a 4G or LTE network, or a 5G network.

That is, the devices 100a to 100e and 200 configuring the AI system 1 may be connected to each other through the cloud network 10. In particular, each of the devices 100a to 100e and 200 may communicate with each other through a base station, but may directly communicate with each other without using a base station.

The AI server 200 may include a server that performs AI processing and a server that performs operations on big data.

The AI server 200 may be connected to at least one of the AI devices constituting the AI system 1, that is, the robot 100a, the self-driving vehicle 100b, the XR device 100c, the smartphone 100d, or the home appliance 100e through the cloud network 10, and may assist at least part of AI processing of the connected AI devices 100a to 100e.

At this time, the AI server 200 may learn the artificial neural network according to the machine learning algorithm instead of the AI devices 100a to 100e, and may directly store the learning model or transmit the learning model to the AI devices 100a to 100e.

At this time, the AI server 200 may receive input data from the AI devices 100a to 100e, may infer the result value for the received input data by using the learning model, may generate a response or a control command based on the inferred result value, and may transmit the response or the control command to the AI devices 100a to 100e.

Alternatively, the AI devices 100a to 100e may infer the result value for the input data by directly using the learning model, and may generate the response or the control command based on the inference result.

Hereinafter, various embodiments of the AI devices 100a to 100e to which the above-described technology is applied will be described. The AI devices 100a to 100e illustrated in FIG. 3 may be regarded as a specific embodiment of the AI device 100 illustrated in FIG. 1.

<AI+Robot>

The robot 100a, to which the AI technology is applied, may be implemented as a guide robot, a carrying robot, a cleaning robot, a wearable robot, an entertainment robot, a pet robot, an unmanned flying robot, or the like.

The robot 100a may include a robot control module for controlling the operation, and the robot control module may refer to a software module or a chip implementing the software module by hardware.

The robot 100a may acquire state information about the robot 100a by using sensor information acquired from various kinds of sensors, may detect (recognize) surrounding environment and objects, may generate map data, may determine the route and the travel plan, may determine the response to user interaction, or may determine the operation.

The robot 100a may use the sensor information acquired from at least one sensor among the lidar, the radar, and the camera so as to determine the travel route and the travel plan.

The robot 100a may perform the above-described operations by using the learning model composed of at least one artificial neural network. For example, the robot 100a may recognize the surrounding environment and the objects by using the learning model, and may determine the operation by using the recognized surrounding information or object information. The learning model may be learned directly from the robot 100a or may be learned from an external device such as the AI server 200.

At this time, the robot 100a may perform the operation by generating the result by directly using the learning model, but the sensor information may be transmitted to the external device such as the AI server 200 and the generated result may be received to perform the operation.

The robot 100a may use at least one of the map data, the object information detected from the sensor information, or the object information acquired from the external apparatus to determine the travel route and the travel plan, and may control the driving unit such that the robot 100a travels along the determined travel route and travel plan.

The map data may include object identification information about various objects arranged in the space in which the robot 100a moves. For example, the map data may include object identification information about fixed objects such as walls and doors and movable objects such as pollen and desks. The object identification information may include a name, a type, a distance, and a position.

In addition, the robot 100a may perform the operation or travel by controlling the driving unit based on the control/interaction of the user. At this time, the robot 100a may acquire the intention information of the interaction due to the user's operation or speech utterance, and may determine the response based on the acquired intention information, and may perform the operation.

<AI+Self-Driving>

The self-driving vehicle 100b, to which the AI technology is applied, may be implemented as a mobile robot, a vehicle, an unmanned flying vehicle, or the like.

The self-driving vehicle 100b may include a self-driving control module for controlling a self-driving function, and the self-driving control module may refer to a software module or a chip implementing the software module by hardware. The self-driving control module may be included in the self-driving vehicle 100b as a component thereof, but may be implemented with separate hardware and connected to the outside of the self-driving vehicle 100b.

The self-driving vehicle 100b may acquire state information about the self-driving vehicle 100b by using sensor information acquired from various kinds of sensors, may detect (recognize) surrounding environment and objects, may generate map data, may determine the route and the travel plan, or may determine the operation.

Like the robot 100a, the self-driving vehicle 100b may use the sensor information acquired from at least one sensor among the lidar, the radar, and the camera so as to determine the travel route and the travel plan.

In particular, the self-driving vehicle 100b may recognize the environment or objects for an area covered by a field of view or an area over a certain distance by receiving the sensor information from external devices, or may receive directly recognized information from the external devices.

The self-driving vehicle 100b may perform the above-described operations by using the learning model composed of at least one artificial neural network. For example, the self-driving vehicle 100b may recognize the surrounding environment and the objects by using the learning model, and may determine the traveling movement line by using the recognized surrounding information or object information. The learning model may be learned directly from the self-driving vehicle 100a or may be learned from an external device such as the AI server 200.

At this time, the self-driving vehicle 100b may perform the operation by generating the result by directly using the learning model, but the sensor information may be transmitted to the external device such as the AI server 200 and the generated result may be received to perform the operation.

The self-driving vehicle 100b may use at least one of the map data, the object information detected from the sensor information, or the object information acquired from the external apparatus to determine the travel route and the travel plan, and may control the driving unit such that the self-driving vehicle 100b travels along the determined travel route and travel plan.

The map data may include object identification information about various objects arranged in the space (for example, road) in which the self-driving vehicle 100b travels. For example, the map data may include object identification information about fixed objects such as street lamps, rocks, and buildings and movable objects such as vehicles and pedestrians. The object identification information may include a name, a type, a distance, and a position.

In addition, the self-driving vehicle 100b may perform the operation or travel by controlling the driving unit based on the control/interaction of the user. At this time, the self-driving vehicle 100b may acquire the intention information of the interaction due to the user's operation or speech utterance, and may determine the response based on the acquired intention information, and may perform the operation.

<AI+XR>

The XR device 100c, to which the AI technology is applied, may be implemented by a head-mount display (HMD), a head-up display (HUD) provided in the vehicle, a television, a mobile phone, a smartphone, a computer, a wearable device, a home appliance, a digital signage, a vehicle, a fixed robot, a mobile robot, or the like.

The XR device 100c may analyzes three-dimensional point cloud data or image data acquired from various sensors or the external devices, generate position data and attribute data for the three-dimensional points, acquire information about the surrounding space or the real object, and render to output the XR object to be output. For example, the XR device 100c may output an XR object including the additional information about the recognized object in correspondence to the recognized object.

The XR device 100c may perform the above-described operations by using the learning model composed of at least one artificial neural network. For example, the XR device 100c may recognize the real object from the three-dimensional point cloud data or the image data by using the learning model, and may provide information corresponding to the recognized real object. The learning model may be directly learned from the XR device 100c, or may be learned from the external device such as the AI server 200.

At this time, the XR device 100c may perform the operation by generating the result by directly using the learning model, but the sensor information may be transmitted to the external device such as the AI server 200 and the generated result may be received to perform the operation.

<AI+Robot+Self-Driving>

The robot 100a, to which the AI technology and the self-driving technology are applied, may be implemented as a guide robot, a carrying robot, a cleaning robot, a wearable robot, an entertainment robot, a pet robot, an unmanned flying robot, or the like.

The robot 100a, to which the AI technology and the self-driving technology are applied, may refer to the robot itself having the self-driving function or the robot 100a interacting with the self-driving vehicle 100b.

The robot 100a having the self-driving function may collectively refer to a device that moves for itself along the given movement line without the user's control or moves for itself by determining the movement line by itself.

The robot 100a and the self-driving vehicle 100b having the self-driving function may use a common sensing method so as to determine at least one of the travel route or the travel plan. For example, the robot 100a and the self-driving vehicle 100b having the self-driving function may determine at least one of the travel route or the travel plan by using the information sensed through the lidar, the radar, and the camera.

The robot 100a that interacts with the self-driving vehicle 100b exists separately from the self-driving vehicle 100b and may perform operations interworking with the self-driving function of the self-driving vehicle 100b or interworking with the user who rides on the self-driving vehicle 100b.

At this time, the robot 100a interacting with the self-driving vehicle 100b may control or assist the self-driving function of the self-driving vehicle 100b by acquiring sensor information on behalf of the self-driving vehicle 100b and providing the sensor information to the self-driving vehicle 100b, or by acquiring sensor information, generating environment information or object information, and providing the information to the self-driving vehicle 100b.

Alternatively, the robot 100a interacting with the self-driving vehicle 100b may monitor the user boarding the self-driving vehicle 100b, or may control the function of the self-driving vehicle 100b through the interaction with the user. For example, when it is determined that the driver is in a drowsy state, the robot 100a may activate the self-driving function of the self-driving vehicle 100b or assist the control of the driving unit of the self-driving vehicle 100b. The function of the self-driving vehicle 100b controlled by the robot 100a may include not only the self-driving function but also the function provided by the navigation system or the audio system provided in the self-driving vehicle 100b.

Alternatively, the robot 100a that interacts with the self-driving vehicle 100b may provide information or assist the function to the self-driving vehicle 100b outside the self-driving vehicle 100b. For example, the robot 100a may provide traffic information including signal information and the like, such as a smart signal, to the self-driving vehicle 100b, and automatically connect an electric charger to a charging port by interacting with the self-driving vehicle 100b like an automatic electric charger of an electric vehicle.

<AI+Robot+XR>

The robot 100a, to which the AI technology and the XR technology are applied, may be implemented as a guide robot, a carrying robot, a cleaning robot, a wearable robot, an entertainment robot, a pet robot, an unmanned flying robot, a drone, or the like.

The robot 100a, to which the XR technology is applied, may refer to a robot that is subjected to control/interaction in an XR image. In this case, the robot 100a may be separated from the XR device 100c and interwork with each other.

When the robot 100a, which is subjected to control/interaction in the XR image, may acquire the sensor information from the sensors including the camera, the robot 100a or the XR device 100c may generate the XR image based on the sensor information, and the XR device 100c may output the generated XR image. The robot 100a may operate based on the control signal input through the XR device 100c or the user's interaction.

For example, the user can confirm the XR image corresponding to the time point of the robot 100a interworking remotely through the external device such as the XR device 100c, adjust the self-driving travel path of the robot 100a through interaction, control the operation or driving, or confirm the information about the surrounding object.

<AI+Self-Driving+XR>

The self-driving vehicle 100b, to which the AI technology and the XR technology are applied, may be implemented as a mobile robot, a vehicle, an unmanned flying vehicle, or the like.

The self-driving driving vehicle 100b, to which the XR technology is applied, may refer to a self-driving vehicle having a means for providing an XR image or a self-driving vehicle that is subjected to control/interaction in an XR image. Particularly, the self-driving vehicle 100b that is subjected to control/interaction in the XR image may be distinguished from the XR device 100c and interwork with each other.

The self-driving vehicle 100b having the means for providing the XR image may acquire the sensor information from the sensors including the camera and output the generated XR image based on the acquired sensor information. For example, the self-driving vehicle 100b may include an HUD to output an XR image, thereby providing a passenger with a real object or an XR object corresponding to an object in the screen.

At this time, when the XR object is output to the HUD, at least part of the XR object may be outputted so as to overlap the actual object to which the passenger's gaze is directed. Meanwhile, when the XR object is output to the display provided in the self-driving vehicle 100b, at least part of the XR object may be output so as to overlap the object in the screen. For example, the self-driving vehicle 100b may output XR objects corresponding to objects such as a lane, another vehicle, a traffic light, a traffic sign, a two-wheeled vehicle, a pedestrian, a building, and the like.

When the self-driving vehicle 100b, which is subjected to control/interaction in the XR image, may acquire the sensor information from the sensors including the camera, the self-driving vehicle 100b or the XR device 100c may generate the XR image based on the sensor information, and the XR device 100c may output the generated XR image. The self-driving vehicle 100b may operate based on the control signal input through the external device such as the XR device 100c or the user's interaction.

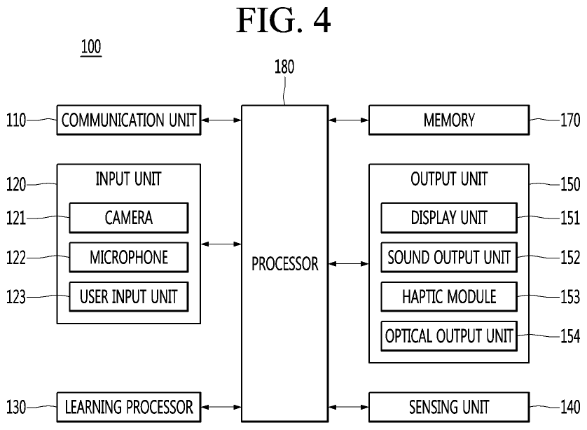

FIG. 4 shows an AI device 100 according to an embodiment of the present invention.

A repeated description of FIG. 1 will be omitted.

Referring to FIG. 4, an input unit 120 may include a camera 121 for receiving a video signal, a microphone 122 for receiving an audio signal and a user input unit 123 for receiving information from a user.

Audio data or image data collected by the input unit 120 may be analyzed and processed as a control command of the user.

The input unit 120 receives video information (or signal), audio information (or signal), data or information received from the user, and the AI device 100 may include one or a plurality of cameras 121 for input of the video information.

The camera 121 processes an image frame such as a still image or a moving image obtained by an image sensor in a video call mode or a shooting mode. The processed image frame may be displayed on a display unit 151 or stored in a memory 170.

The microphone 122 processes external acoustic signals into electrical sound data. The processed sound data may be variously utilized according to the function (or the application program) performed in the AI device 100. Meanwhile, various noise removal algorithms for removing noise generated in a process of receiving the external acoustic signal is applicable to the microphone 122.

The user input unit 123 receives information from the user. When information is received through the user input unit 123, a processor 180 may control operation of the AI device 100 in correspondence with the input information.

The user input unit 123 may include a mechanical input element (or a mechanical key, for example, a button located on a front/rear surface or a side surface of the terminal 100, a dome switch, a jog wheel, a jog switch, and the like) and a touch input element. As one example, the touch input element may be a virtual key, a soft key or a visual key, which is displayed on a touchscreen through software processing, or a touch key located at a portion other than the touchscreen.

An output unit 150 may include at least one of a display unit 151, a sound output unit 152, a haptic module 153, and an optical output unit 154.

The display unit 151 displays (outputs) information processed in the AI device 100. For example, the display unit 151 may display execution screen information of an application program executing at the AI device 100 or user interface (UI) and graphical user interface (GUI) information according to the execution screen information.

The display unit 151 may have an inter-layered structure or an integrated structure with a touch sensor so as to implement a touchscreen. The touchscreen may provide an output interface between the terminal 100 and a user, as well as functioning as the user input unit 123 which provides an input interface between the AI device 100 and the user.

The sound output unit 152 may output audio data received from a communication unit 110 or stored in the memory 170 in a call signal reception mode, a call mode, a record mode, a voice recognition mode, a broadcast reception mode, and the like.

The sound output unit 152 may include at least one of a receiver, a speaker, a buzzer or the like.

The haptic module 153 may generate various tactile effects that can be felt by a user. A representative example of tactile effect generated by the haptic module 153 may be vibration.

The optical output unit 154 may output a signal indicating event generation using light of a light source of the AI device 100. Examples of events generated in the AI device 100 may include a message reception, a call signal reception, a missed call, an alarm, a schedule notice, an email reception, an information reception through an application, and the like.

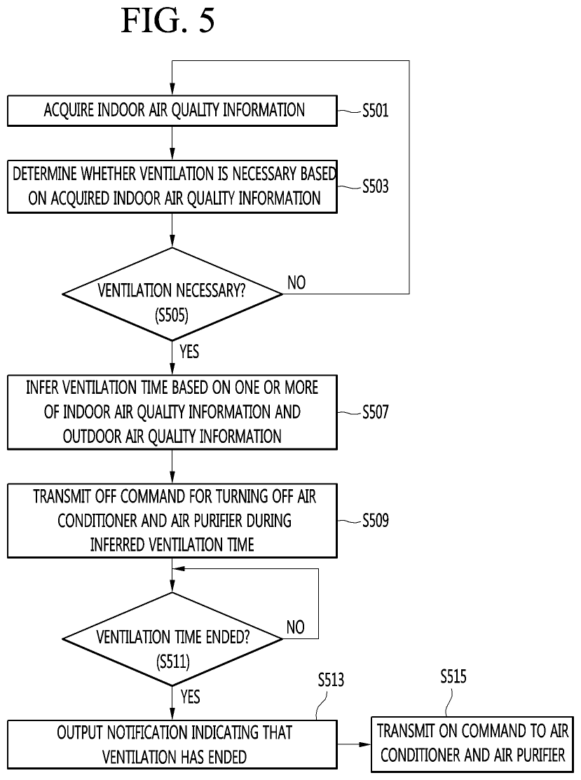

FIG. 5 is a flowchart illustrating a method of operating an AI device according to an embodiment of the present invention.

In particular, FIG. 5 is a view illustrating an operating method for optimizing indoor ventilation.

Hereinafter, assume that the AI device 100, an air conditioner and an air purifier are located indoors.

The processor 180 of the AI device acquires indoor air quality information (S501).

The indoor air quality information may include one or more of fine dust information and carbon dioxide information.

The fine dust information may include at least one of an indoor fine dust concentration and an indoor ultrafine dust concentration.

The ultrafine dust concentration may include a volatile organic compound (VOC) concentration.

The carbon dioxide information may include the concentration of carbon dioxide measured indoors.

The processor 180 may receive indoor air quality information from the AI server 200 through the communication unit 110. In another example, the processor 180 may receive indoor air quality information from an air quality measurement sensor located indoors.

Meanwhile, the processor 180 may acquire outdoor air quality information in addition to the indoor air quality information.

The outdoor air quality information may include a fine dust concentration, an ultrafine dust concentration and a carbon dioxide concentration measured outdoors.

The processor 180 may receive the outdoor air quality information from the AI server 200 through the communication unit 110.

The processor 180 of the AI device determines whether ventilation is necessary based on the acquired indoor air quality information (S503).

For example, when the indoor fine dust concentration is equal to or greater than a certain concentration, the processor 180 may determine that indoor ventilation is necessary.

In another example, when the indoor fine dust concentration is equal to or greater than a certain concentration and the ultrafine dust concentration is equal to or greater than a certain concentration, the processor 180 may determine that indoor ventilation is necessary.

In another example, when the indoor fine dust concentration is equal to or greater than a certain concentration, the ultrafine dust concentration is equal to or greater than a certain concentration and the carbon dioxide concentration is equal to or greater than a certain concentration, the processor 180 may determine that indoor ventilation is necessary.

In another example, although the indoor fine dust concentration is equal to or greater than the certain concentration, when the outdoor fine dust concentration is greater than the indoor fine dust concentration, the processor 180 may determine that indoor ventilation is unnecessary.

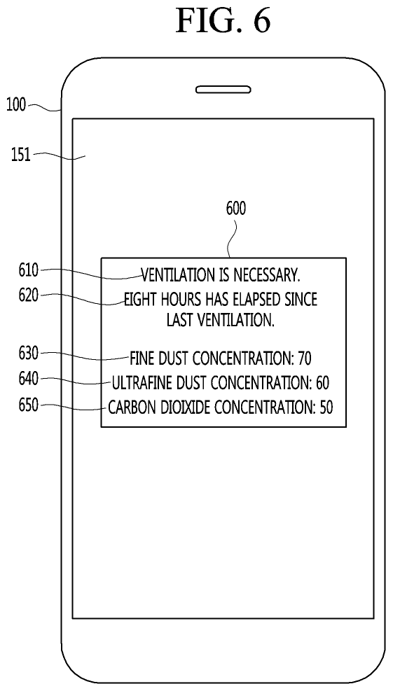

Meanwhile, upon determining that ventilation is necessary, the processor 180 may output a notification indicating that indoor ventilation is necessary through the output unit 150. This will be described with reference to FIG. 6.

FIG. 6 is a view illustrating an example of outputting a notification indicating that ventilation is necessary according to an embodiment of the present invention.

Referring to FIG. 6, the display unit 151 of the AI device 100 may display a notification indicating that ventilation is necessary.

The notification 600 may include first text 610 indicating that ventilation is necessary, second text 620 indicating a time elapsed since a last ventilation time, a fine dust concentration 630, an ultrafine dust concentration 640 and a carbon dioxide concentration 650.

The user may rapidly check that ventilation is necessary without separate search through the notification 600.

In another example, the AI device 100 may output the notification indicating that ventilation is necessary through the sound output unit 152.

Refer to FIG. 5 again.

Upon determining that ventilation is necessary, the processor 180 infers a ventilation time based on one or more of the indoor air quality information and the outdoor air quality information (S507).

The processor 180 may infer the ventilation time using one or more of the indoor air quality information and the outdoor air quality information and a ventilation time inference model.

The ventilation time inference model may be an artificial neural network based model learned by a deep learning algorithm or a machine learning algorithm.

In particular, the ventilation time inference model may be learned using a regression analysis deep learning algorithm.

The regression analysis deep learning algorithm may refer to an algorithm that generates a hypothesis from learning data, inputs data into the generated hypothesis and obtains a predicted value.

In the present invention, the hypothesis may be an equation and the coefficient of the equation may be optimized through learning. Specifically, the coefficient of the equation may be learned through a cost function, such that a difference between the equation and a data distribution is minimized.

The equation may represent correlation between air quality information including the indoor air quality information and the outdoor air quality information and the ventilation time.

In the present invention, the learning data may include the indoor air quality information, the outdoor air quality information and the ventilation time.

The ventilation time inference model may determine the optimal coefficient of the equation using the indoor air quality information, the outdoor air quality information and the ventilation information.

When indoor air quality data and outdoor air quality data, which are input data, are input to the ventilation time inference model, the ventilation time inference model may infer an optimal ventilation time using the equation having the determined optimal coefficients.

This will be described with reference to the following drawings.

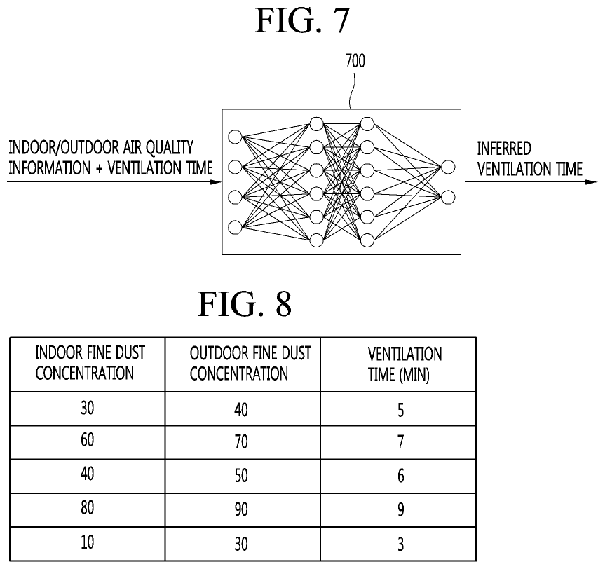

FIG. 7 is a view illustrating a ventilation time inference model according to an embodiment of the present invention. FIG. 8 is a view showing an example of learning data used to learn the ventilation time inference model.

Referring to FIG. 7, the ventilation time inference model 700 may determine the coefficient of the equation for minimizing a difference between the inferred ventilation time and the input ventilation time, using the indoor air quality information, the outdoor air quality information and the ventilation time as learning data.

The ventilation time inference model 700 may be learned by the learning processor 240 of the AI server 200.

The AI server 200 may transmit the ventilation time inference model 700 to the AI device 100, and the AI device 100 may store the received ventilation time inference model 700 in the memory 170.

In another example, the ventilation time inference model 700 may be learned by the learning processor 130 of the AI device 100 and stored in the memory 170.

Referring to FIG. 8, an example of the learning data is shown. That is, the ventilation time corresponding to an indoor fine dust concentration and an outdoor fine dust concentration may be used as learning data.

The ventilation time inference model 700 may determine an optimal equation coefficient from various data distributions.

FIG. 5 will be described again.

The processor 180 transmits an OFF command for turning off the air conditioner or the air purifier during the inferred ventilation time to one or more of the air conditioner and the air purifier through the communication unit 110 (S509).

When the ventilation time is determined, the processor 180 may transmit the OFF command for turning off operation of the air conditioner or the air purifier to one or more of the air conditioner or the air purifier, for ventilation during the determined ventilation time.

The air conditioner or the air purifier may change the ON state to the OFF state according to the OFF command received from the AI device 100. The OFF command may include a ventilation time when the OFF state of the air conditioner or the air purifier is maintained.

The air conditioner or the air purifier may be turned off during the ventilation time according to the received OFF command.

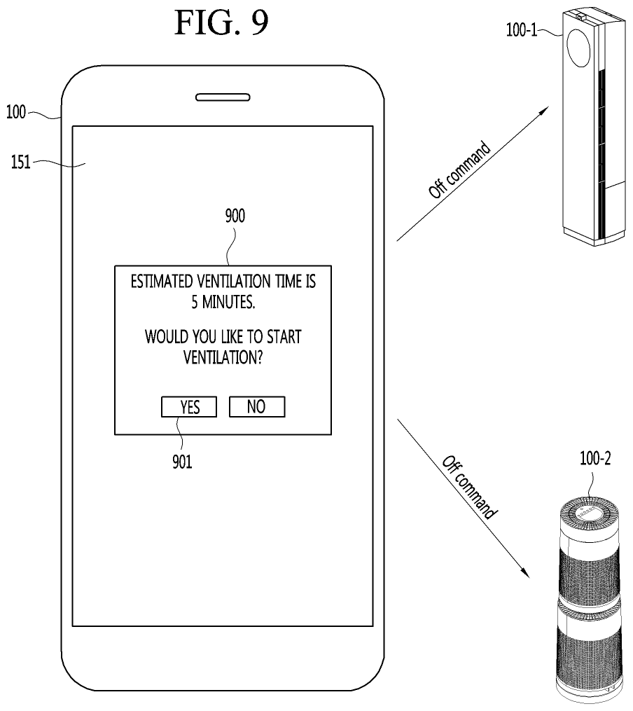

Step S509 will be described with reference to FIG. 9.

FIG. 9 is a view illustrating a process of turning off operation of an external AI device during a ventilation time according to an embodiment of the present invention.

When the ventilation time is determined, the processor 180 may display a notification 900 including the determined ventilation time through the display unit 151.

When an YES button 901 is selected, the processor 180 may transmit the OFF command for turning off power during the ventilation time to the air conditioner 100-1 and the air conditioner 100-2.

The processor 180 may transmit the OFF command to the air conditioner 100-1 and the air purifier 100-2 through a short-range communication module included in the communication unit 110. The short-range communication module may use the Bluetooth standard or the Wi-Fi standard.

The air conditioner 100-1 and the air purifier 100-2 may be turned off according to the received OFF command.

In another example, the processor 180 may automatically transmit the OFF command to the air conditioner 100-1 and the air purifier 100-2 without selection of the YES button 901, when the ventilation time is determined.

According to the embodiment of the present invention, a situation in which ventilation is necessary may be automatically detected, thereby improving indoor air quality. In addition, operation of the air conditioner or the air purifier unnecessary for ventilation may be automatically turned off, thereby improving user convenience.

FIG. 5 will be described again.

The processor 180 determines whether the ventilation time has ended (S511), and outputs a ventilation end notification through the output unit 150 when the ventilation time has ended (S513).

When the ventilation time has ended, the processor 180 may indicate that a ventilation situation has ended and output a ventilation end notification through the display unit 151 or the sound output unit 152.

Thereafter, the processor 180 transmits an ON command for turning on the air conditioner or the air purifier to one or more of the air conditioner or the air purifier through the communication unit 110 (S515).

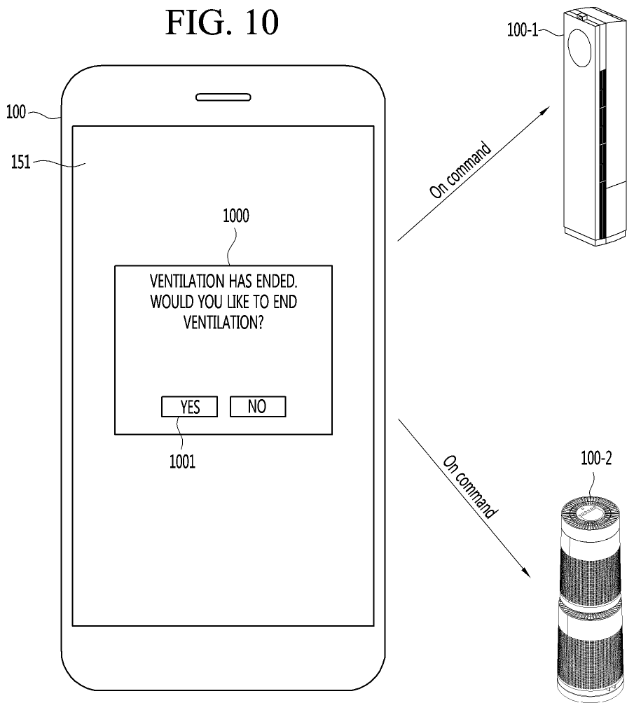

This will be described with reference to FIG. 10.

FIG. 10 is a view illustrating a process of transmitting an ON command to an external AI device when ventilation has ended according to an embodiment of the present invention.

When the ventilation time has elapsed, the processor 180 may display a notification 1000 indicating that ventilation has ended through the display unit 151. When an YES button 1001 is selected, the processor 180 may transmit an ON command for turning on operation of the air conditioner 100-1 and the air purifier 100-2 through a short-range communication module.

In another example, the processor 180 may automatically transmit the ON command to the air conditioner 100-1 and the air purifier 100-2 through the short-range communication module without selection of the YES button 1001, when the ventilation time has elapsed.

In another example, the processor 180 may output the notification 1000 through the sound output unit 152.

According to the embodiment of the present invention, when ventilation has ended, it is possible to automatically turn on the air conditioner and the air purifier without separate user operation.

Meanwhile, when the ventilation time has ended, the processor 180 may output a notification for extending the ventilation time.

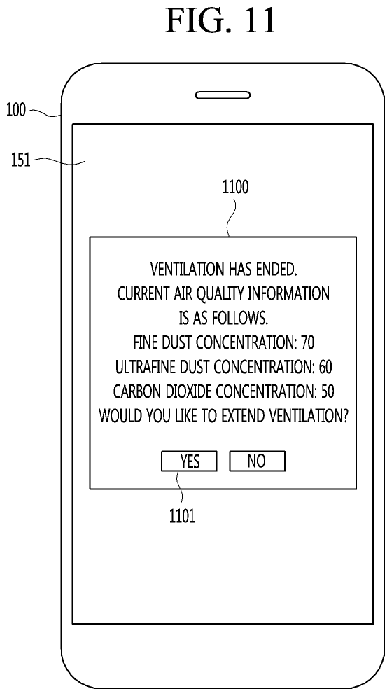

FIG. 11 is a view illustrating a notification indicating that ventilation may be extended when ventilation has ended according to an embodiment of the present invention.

Referring to FIG. 11, when the ventilation time has ended, the processor 180 may output a notification 1100 indicating that ventilation has ended and asking about whether or not the ventilation time needs to be extended through the display unit 151.

The notification 1100 may further include information on a current indoor fine dust concentration, a current indoor ultrafine dust concentration and a current indoor carbon dioxide concentration.

When the YES button 1101 is selected, the processor ⁸ may display information on a ventilation time to be extended. When a specific ventilation time is selected, the processor may transmit an OFF maintaining command for turning off operation of the air conditioner 100-1 or the air purifier 100-2 to the air conditioner 100-1 and the air purifier 100-2 during the selected specific ventilation time.

According to the embodiment of the present invention, a situation in which ventilation is necessary may be automatically detected, thereby improving indoor air quality. In addition, operation of an air conditioner or an air purifier unnecessary for ventilation may be automatically turned off, thereby improving user convenience.

In addition, when a ventilation time has ended, operation of the air conditioner or the air purifier may be turned on without separate user operation.

The present invention mentioned in the foregoing description can also be embodied as computer readable codes on a computer-readable recording medium. Examples of possible computer-readable mediums include HDD (Hard Disk Drive), SSD (Solid State Disk), SDD (Silicon Disk Drive), ROM, RAM, CD-ROM, a magnetic tape, a floppy disk, an optical data storage device, etc. The computer may include the controller 180 of the AI device.

What is claimed is:

1. An artificial intelligence (AI) device for automatically checking a ventilation situation, the AI device comprising:
a memory;
a communication unit configured to wirelessly perform communication with an external AI device; and
one or more processors coupled with the memory and configured to:
acquire indoor air quality information and outdoor air quality information;
determine whether ventilation is necessary based on the acquired indoor air quality information;
acquire a ventilation time based on the indoor air quality information and the outdoor air quality information in response to determining that the ventilation is necessary; and
control the communication unit to transmit, to the external AI device, an OFF command for turning off operation of the external AI device during the acquired ventilation time.

2. The AI device of claim 1,
wherein the indoor air quality information includes one or more of an indoor fine dust concentration, an indoor ultrafine dust concentration or an indoor carbon dioxide concentration, and
wherein the outdoor air quality information includes one or more of an outdoor fine dust concentration, an outdoor ultrafine dust concentration or an outdoor carbon dioxide concentration.

3. The AI device of claim 2, wherein the one or more processors are further configured to determine that the ventilation is necessary, based on the indoor fine dust concentration being equal to or greater than a first certain concentration and the indoor ultrafine dust concentration being equal to or greater than a second certain concentration.

4. The AI device of claim 2,
wherein the memory stores a ventilation time inference model trained through a deep learning algorithm, and
wherein the one or more processors are further configured to acquire the ventilation time using the ventilation time inference model based on the indoor air quality information and the outdoor air quality information.

5. The AI device of claim 4, wherein the ventilation time inference model determines, using a regression analysis deep learning algorithm, a coefficient of an equation indicating correlation between air quality information including the indoor air quality information and the outdoor air quality information and the ventilation time.

6. The AI device of claim 1, further comprising an output unit including one or more of a display unit or a sound output unit,
wherein the one or more processors are further configured to output, through the output unit, a notification indicating that the ventilation has ended.

7. The AI device of claim 6, wherein the one or more processors are further configured to control the communication unit to transmit, to the external AI device, an ON command for turning on the operation of the external AI device, when the ventilation time has ended.

8. The AI device of claim 1, further comprising an output unit including one or more of a display unit or a sound output unit,
wherein the one or more processors are further configured to output, through the output unit, a notification indicating that the ventilation is necessary.

9. The AI device of claim 1, wherein the external AI device is an air conditioner or an air purifier.

10. The AI device of claim 1, wherein the communication unit receives the indoor air quality information and the outdoor air quality information from an AI server.

11. A method of operating an artificial intelligence (AI) device for automatically checking a ventilation situation, the method comprising:
acquiring indoor air quality information and outdoor air quality information;
determining whether ventilation is necessary based on the acquired indoor air quality information;
acquiring a ventilation time based on the indoor air quality information and the outdoor air quality information, in response to determining that the ventilation is necessary; and
transmitting, to an external AI device, an OFF command for turning off operation of the external AI device during the acquired ventilation time.

12. The method of claim 11,
wherein the indoor air quality information includes one or more of an indoor fine dust concentration, an indoor ultrafine dust concentration or an indoor carbon dioxide concentration, and
wherein the outdoor air quality information includes one or more of an outdoor fine dust concentration, an outdoor ultrafine dust concentration or an outdoor carbon dioxide concentration.

13. The method of claim 12, wherein the ventilation is determined to be necessary, based on the indoor fine dust concentration being equal to or greater than a first certain concentration and the indoor ultrafine dust concentration being equal to or greater than a second certain concentration.

14. The method of claim 12, wherein the ventilation time is acquired using a ventilation time inference model based on the indoor air quality information and the outdoor air quality information, wherein the ventilation time inference model is trained through a deep learning algorithm.

15. The method of claim 14, wherein the ventilation time inference model determines, using a regression analysis deep learning algorithm, a coefficient of an equation indicating correlation between air quality information including the indoor air quality information and the outdoor air quality information and the ventilation time.

16. The method of claim 11, further comprising outputting a notification indicating that the ventilation has ended.

17. The method of claim 16, further comprising transmitting, to the external AI device, an ON command for turning on the operation of the external AI device, when the ventilation time has ended.

18. The method of claim 11, further comprising outputting a notification indicating that the ventilation is necessary.

19. The method of claim 11, wherein the external AI device is an air conditioner or an air purifier.

20. The method of claim 11, wherein the acquiring of the indoor air quality information and the outdoor air quality information includes receiving the indoor air quality information and the outdoor air quality information from an AI server.
